(19) United States
(12) Patent Application Publication
(10) Pub. No.: US 2013/0242569 A1
(43) Pub. Date: Sep. 19, 2013

(54) Substrate for Carrying Light Emitting Diodes and Manufacturing Method Thereof

(71) Applicants: Chun-Te Wu, Yangmei City (TW); Chia-Tsen Huang, Yangmei City (TW)

(72) Inventors: Chun-Te Wu, Yangmei City (TW); Chia-Tsen Huang, Yangmei City (TW)

(73) Assignee: WALSIN LIHWA CORPORATION, Yangmei City (TW)

(21) Appl. No.: 13/469,371

(22) Filed: May 11, 2012

(30) Foreign Application Priority Data
Mar. 14, 2012 (TW) 101108570

(51) Int. Cl. F21V 7/04; B29D 11/00; G02B 1/12; F21V 7/00

(52) U.S. Cl. 362/347; 362/341; 264/1.9; 264/1.38

(57) ABSTRACT

A substrate for carrying light emitting diodes and a manufacturing method thereof are provided. The substrate includes a bottom portion, a side portion and a reflective element. The side portion is disposed on the bottom portion. An upper surface of the bottom portion and an inner surface of the side portion define a recess where the light emitting diodes and the reflective element are disposed. More specifically, the light emitting diodes are disposed on the upper surface, while the reflective element is disposed along the inner surface of the recess. With the above-mentioned arrangements, the light extraction efficiency of the light emitting diodes can be increased.

This application claims priority to Taiwan Patent Application No. 101108570 filed on Mar. 14, 2012, which are hereby incorporated herein by reference in their entirety.

### CROSS-REFERENCES TO RELATED APPLICATIONS

Not applicable.

### BACKGROUND OF THE INVENTION

1. Field of the Invention

The present invention relates to a substrate and a manufacturing method thereof More particularly, the present invention relates to a substrate for carrying light emitting diodes (LEDs) and a manufacturing method thereof.

2. Descriptions of the Related Art

Light emitting diodes (LEDs) are widely used in various industries due to their advantages such as low power consumption, a high efficiency, rapid response time, a long service life and environmental friendly. In order to use more efficiently and increase flexibility, almost every manufacturer in this industry is making efforts to increase the brightness and efficiency of the LEDs. Additionally, a major development objective in this industry is to provide a method for effectively improving the light extraction efficiency of the LEDs so as to improve the overall efficiency of the LEDs.

In order to concentrate the light emitted from LEDs, LEDs are usually disposed in a light cup with an opening. The light cup is adapted to concentrate the light and finally project the light outwards through the opening. Unfortunately, this usually has a poor effect. In detail, there are mainly two kinds of technologies for forming a light cup. According to the first kind of technology, a laser is used to cut a circular hole in an upper plate, and then the upper plate formed with the circular hole is joined with a lower plate to form a substrate structure for placing LEDs thereon. According to the other kind of technology, a low-temperature co-fired multilayer ceramic process is used. Additionally, a structure for enhancing the concentration of sidelight towards the opening may be optionally designed, for example, by forming an inner surface of the light cup as an inclined surface. However, the inner surface of the light cup formed by the laser process only can be formed as a vertical surface, which fails to satisfy the aforesaid requirement; and for the light cup substrate formed through the fired ceramic process, although a customized inner surface can be obtained, the cost is at least five times that of the laser process, which is relatively cost-ineffective.

Given the above, it is important to provide a light cup substrate which is inexpensive in cost and simple to manufacture and also allows for customizing an inner surface thereof to improve the light extraction efficiency of LEDs.

### SUMMARY OF THE INVENTION

An objective of the present invention is to provide a substrate for carrying light emitting diodes (LEDs) and a manufacturing method thereof The substrate can concentrate light emitted from the LEDs and improve the light extraction efficiency of the LEDs, and moreover, is inexpensive in cost and simple to manufacture.

To achieve the aforesaid objective, the present invention provides a substrate for carrying light emitting diodes, which comprises a bottom portion, a side portion and a reflective element. The side portion is disposed on the bottom portion, while an upper surface of the bottom portion and an inner surface of the side portion define a recess. In other words, the recess is defined by the upper surface of the bottom portion and the inner surface of the side portion. The light emitting diodes are disposed on the upper surface, while the reflective element is disposed in the recess along the inner surface. With this arrangement, the light extraction efficiency of the light emitting diodes can be improved thereby.

The present invention further provides a method for manufacturing the aforesaid substrate for carrying multiple light emitting diodes. First, a reflective material is disposed along the inner surface within the recess of the substrate. Then, a mold is pressed into the recess to shape the reflective material. Finally, the mold is removed to obtain the substrate for carrying light emitting diodes.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic cross-sectional view of an embodiment according to the present invention; and

FIGS. 2A to 2D are schematic views illustrating the process flow for manufacturing a substrate of the embodiment of FIG. 1.

### DESCRIPTION OF THE PREFERRED EMBODIMENT

In the following descriptions, the present invention will be explained with reference to embodiments thereof The present invention provides a substrate for carrying light emitting diodes (LEDs) and a manufacturing method thereof.

It shall be appreciated that in the following embodiments and attached drawings, the description of these embodiments is only for the purpose of illustration rather than limitation. Meanwhile, in the following embodiments and the attached drawings, elements not directly related to the present invention are omitted; and the dimensional relationships among the individual elements in the attached drawings are illustrated only for the ease of understanding but not to limit the actual scale.

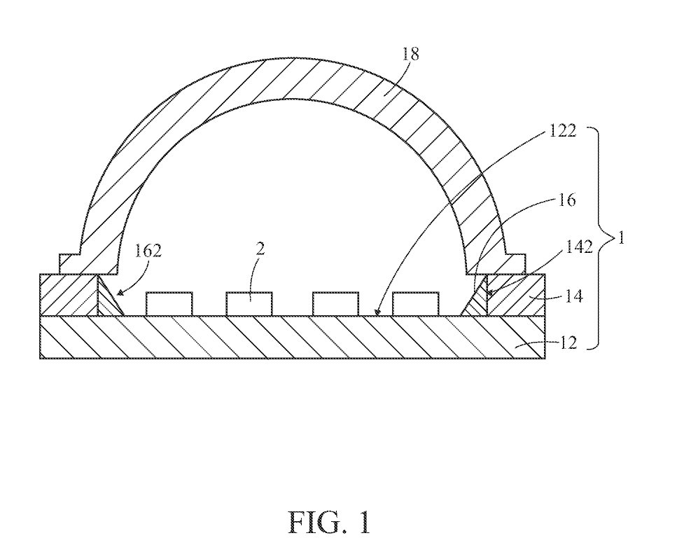

First, FIG. 1 illustrates a schematic cross-sectional view of an embodiment according to the present invention. A substrate 1 for carrying LEDs 2, the LEDs 2 and a cover 18 that covers the substrate 1 and the LEDs 2 are shown therein.

The substrate 1 comprises a bottom portion 12, a side portion 14 and a reflective element 16. The bottom portion 12 is a plate with a hollow portion. The hollow portion is formed through laser cutting, and has a circular shape when being viewed from the top. In other embodiments, the hollow portion may also have an elliptical shape, a rectangular shape, a polygonal shape or some other irregular shape when being viewed from the top. The side portion 14 is disposed on the bottom portion 12, while an upper surface 122 of the bottom portion 12 and an inner surface 142 of the side portion 14 define a recess. In other words, the recess is defined by the upper surface 122 of the bottom portion 12 and the inner surface 142 of the side portion 14. The LEDs 2 are disposed in the recess. In detail, the LEDs 2 are disposed on the upper surface 122 in the recess. The reflective element 16 is continuously disposed within the recess along the inner surface 142 of the side portion 14.

When a light beam is emitted from the LEDs 2, divergent sidelight of the light beam will be reflected by a surface 162 of the reflective element 16 to concentrate the light beam. Thereby, the overall light extraction efficiency can be improved significantly.

Furthermore, a cover 18 may be further applied to cover the substrate 1 and the LEDs 2 in this embodiment. The cover 18 is disposed on the side portion 14 and completely covers the recess. The cover 18 may be designed to have different curved surfaces depending on the different requirements for concentrating/diverging the light generated by the LEDs 2.

In detail, the phrase “the reflective element 16 is disposed within the recess ‘along’ the inner surface 142” means that the reflective element 16 is continuously disposed around and attached to a junction where the inner surface 142 and the upper surface 122 are intersected, but is not merely limited to the fact that the reflective element 16 is only disposed on the inner surface 142. The purpose of this arrangement is as follows: in the prior art, a part of light from the LEDs enters at a right-angled portion of the recess which causes unexpected reflected light or causes the reflected light that is difficult to be extracted. In contrast, by disposing the reflective element 16 at the right-angled portion in the recess according to the present invention, a sidelight can be guided to a particular angle to improve the light extraction efficiency.

It shall be further described that the bottom portion 12 and the side portion 14 of this embodiment may be a circuit board or a printed circuit board (PCB) composed of at least one of ceramics, Cu, Al, Si or glass fibers, independently. In this embodiment, the bottom portion 12 and the side portion 14 are made of different materials. In other embodiments, the bottom portion 12 and the side portion 14 may also be made of a same material or even further be integrally formed. The material of the reflective element 16 of this embodiment may be selected from silicone, a cold-setting material (e.g., clay or a plastic injection material), a thermosetting material (e.g., an epoxy resin), a thermoplastic material (e.g., polycarbonate (PC) or an ABS resin), or an ultraviolet setting material (e.g., an UV gel). Although the reflective surface 162 of the reflective element 16 in FIG. 1 is an inclined surface, the inclined surface may also be replaced by a curved surface, a wavy surface or a stepped surface depending on the user's requirements.

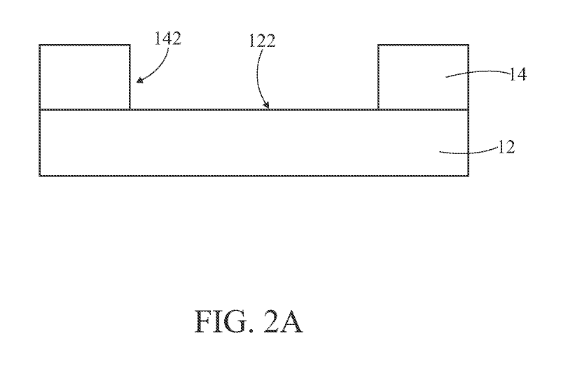

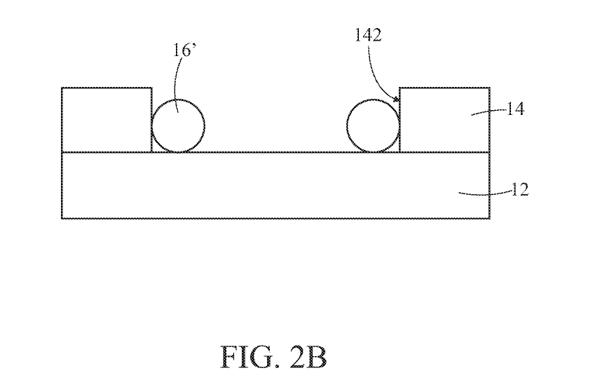

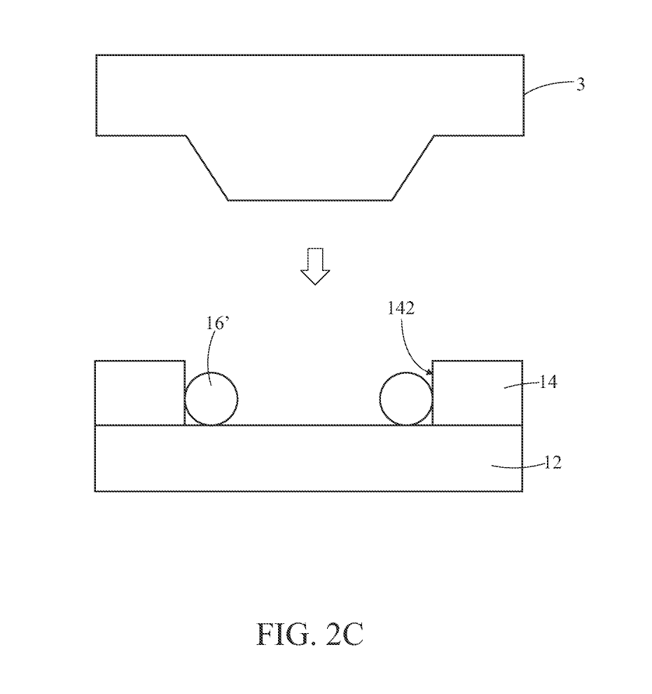

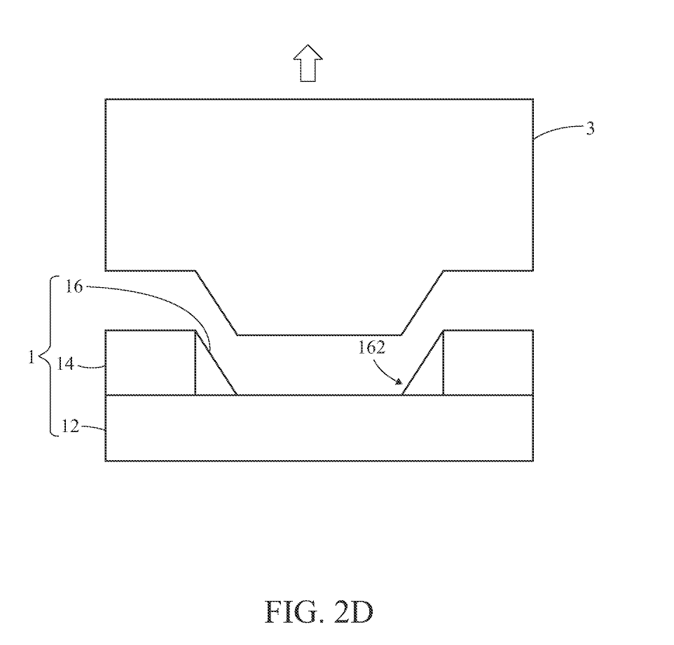

Next, please refer to FIGS. 2A to 2D, schematic views illustrating a process flow for manufacturing the aforesaid substrate 1 are shown. The method for manufacturing the substrate 1 comprises the steps as follows. First, as shown in FIG. 2A, a substrate 1 is provided. An upper surface 122 of a bottom portion 12 of the substrate 1 and a side portion 14 with an inner surface 142 define a recess. Then, as shown in FIG. 2B, a reflective material 16′ is disposed in the recess at sites adjacent to the inner surface 142. The reflective material 16′ may be, for example, silicone, a cold-setting material (e.g., clay or a plastic injection material), a thermosetting material (e.g., an epoxy resin), a thermoplastic material (e.g., PC or an ABS resin), or an ultraviolet setting material (e.g., an UV gel). Then, with reference to FIGS. 2C and 2D, a mold 3 is pressed into the recess to shape the reflective material 16′, and this deforms the reflective material 16′ that is in a semi-cured status; i.e., the reflective material 16′ is spread along and uniformly attached to the inner surface 142 and the upper surface 122. Finally, the mold 3 is removed to form the substrate 1.

Furthermore, before removing the mold 3, the method according to the present invention may further comprise a step of curing for curing the shaped reflective material 16′ to form a reflective element 16. The step of curing may be achieved by a cold-setting process, a baking process or an ultraviolet curing process, which is chosen depending on the reflective material 16′. Furthermore, in order to satisfy the demands for different optical angles, the shape of the reflective surface 162 of the reflective element 16 may be adjusted by adjusting the shape of the mold 3; i.e. by using the mold 3 to press the reflective material 16′, the reflective material 16′ can be deformed to form a reflective element 16 whose reflective surface 162 is complementary to the shape of the mold 3. Therefore, as described above, although the reflective surface 162 of the reflective element 16 in FIG. 2D is an inclined surface; the inclined surface may be replaced by a curved surface, a wavy surface or a stepped surface depending on the user's requirements. Furthermore, it is necessary to ensure that the step of disposing the reflective material 16′ in the recess is after the pressing and curing processes so that the reflective material 16′ can surely form a reflective element 16 which is integrally formed and continuously disposed along the inner surface 142.

According to the above descriptions, by disposing a reflective element with a reflective surface within a recess of a substrate and through the arrangement of LEDs and the reflective element on the substrate according to the present invention, the sidelight emitted from the LEDs can be recycled by the reflective surface to achieve the purpose of improving the overall light extraction efficiency of the LEDs. Furthermore, the present invention provides a simple manufacturing process with low cost that substantially satisfies the need in the art.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A substrate for carrying light emitting diodes, comprising:
a bottom portion;
a side portion, disposed on the bottom portion, wherein an upper surface of the bottom portion and an inner surface of the side portion define a recess and the light emitting diodes are disposed on the upper surface in the recess; and
a reflective element, disposed along the inner surface of the side portion within the recess.

2. The substrate as claimed in claim 1, wherein the reflective element has a reflective surface, which is a curved surface.

3. The method as claimed in claim 1, wherein the reflective element has a reflective surface, which is an inclined surface.

4. The method as claimed in claim 1, wherein the reflective element has a reflective surface, which is a wavy surface.

5. The method as claimed in claim 1, wherein the reflective element has a reflective surface, which is a stepped surface.

6. The substrate as claimed in claim 1, wherein the bottom portion is a circuit board or a printed circuit board (PCB) composed of at least one of ceramics, Cu, Al, Si or glass fibers.

7. The substrate as claimed in claim 1, wherein the side portion is a circuit board or a printed circuit board composed of at least one of ceramics, Cu, Al, Si or glass fibers.

8. The substrate as claimed in claim 1, wherein the material of the reflective element is selected from silicone, a cold-setting material, a thermoplastic material, a thermosetting material, or an ultraviolet setting material.

9. The substrate as claimed in claim 1, wherein the bottom portion is integrally formed with the side portion.

10. A method for manufacturing a substrate for carrying light emitting diodes, comprising:
disposing a reflective material in a recess, wherein the recess is defined by an upper surface of a bottom portion of the substrate and an inner surface of a side portion of the substrate and the reflective material is disposed along the inner surface within the recess;
pressing a mold into the recess and shaping the reflective material; and
removing the mold.

11. The method as claimed in claim 10, which further comprises a step of curing the shaped reflective material to form a reflective element before the removing step.

12. The method as claimed in claim 10, wherein the curing step is achieved by a baking curing process.

13. The method as claimed in claim 10, wherein the curing step is achieved by a cold-setting process.

14. The method as claimed in claim 10, wherein the curing step is achieved by an ultraviolet curing process.

15. The method as claimed in claim 10, wherein the reflective element has a reflective surface, which is a curved surface.

16. The method as claimed in claim 10, wherein the reflective element has a reflective surface, which is an inclined surface.

17. The method as claimed in claim 10, wherein the reflective element has a reflective surface, which is a wavy surface.

18. The method as claimed in claim 10, wherein the reflective element has a reflective surface, which is a stepped surface.
